(19) United States
(12) Patent Application Publication
(10) Pub. No.: US 2014/0150725 A1
(43) Pub. Date: Jun. 5, 2014

(54) BIRDFEEDER

(71) Applicant: Thomas Keith Moone, Chargin Falls, OH (US)

(72) Inventor: Thomas Keith Moone, Chargin Falls, OH (US)

(73) Assignee: Nature's Way LLC, Chargin Falls, OH (US)

(21) Appl. No.: 13/892,004

(22) Filed: May 10, 2013

Related U.S. Application Data
(60) Provisional application No. 61/645,563, filed on May 10, 2012.

(51) Int. Cl. A01K 39/01

(52) U.S. Cl. CPC A01K 39/01
USPC 119/57.8; 119/51.01

(57) ABSTRACT

A birdfeeder (10) comprising a housing (20) having a hexagonal tube with an open top and an open bottom. Feed-port inserts (30) and perches (40) are securely but removably attached to the housing (20) via keyed contours. A roof (50) and a base (60) are also securely but removably attached to the housing (20).

### RELATED APPLICATION

This application claims priority under 35 USC §119(e) to U.S. Provisional Patent Application No. 61/645563 filed on May 10, 2012. The entire disclosure of this provisional patent application is hereby incorporated by reference.

### BACKGROUND

A birdfeeder is often placed in a backyard or other outside venues to attract birds to the area. One popular type of birdfeeder comprises a tubular hexagonal housing having feed-enhancing attachments such as feeding ports, perches, and/or baffles. A roof covers the top of the housing and a base encloses the bottom of the housing.

### SUMMARY

A birdfeeder comprises a tubular hexagonal housing, easily removable feed-enhancing attachments (e.g., feeding ports, perches, baffles, etc.), an easily removable roof, and/or an easily removable base.

### DRAWINGS

FIG. 1 shows a birdfeeder 10.

FIGS. 2-7 show a housing 20, a feed-port insert 30, a perch 40, a roof 50, a base 60, and a baffle 70.

FIG. 8 shows a birdfeeder 10 without feed-port inserts.

### DESCRIPTION

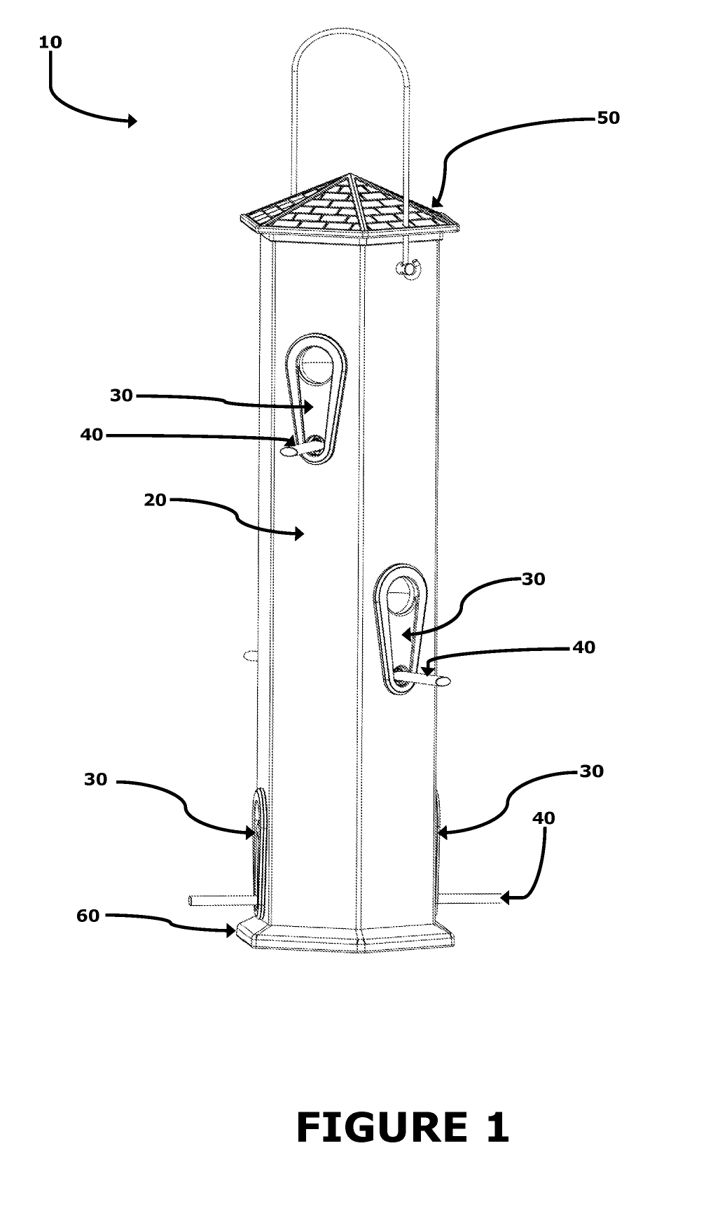

Referring now to the drawings, and initially to FIG. 1, a birdfeeder 10 is shown which comprises a housing 20, feeding ports 30, perches 40, a roof 50, and a base 60. As is explained in more detail below, the feeding ports 30, the perches 40, the roof 50, and the base 60 can be constructed so that they are securely attached, yet easily removable (i.e., without special tools or skills) from the housing 20. In this manner, the birdhouse 10 can be shipped and stored compactly, it can be easily assembled for use, and/or it can be easily disassembled for a thorough cleaning of the housing 20.

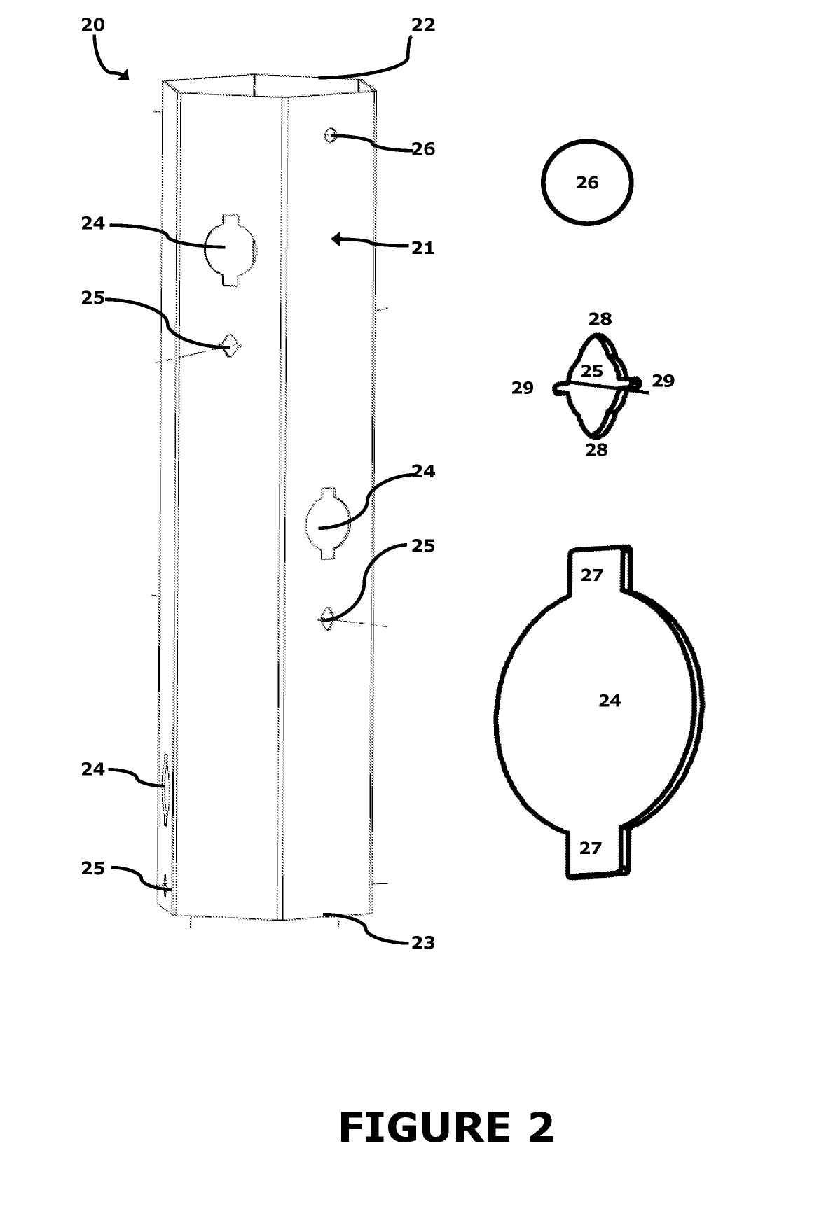

Referring to FIG. 2, the housing 20 comprises a hexagonal tube 21 having a top edge 22 and a bottom edge 23. Upper, lower, and middle pairs of aligned port-receiving holes 24 and aligned perch-receiving holes 25 are distributed among the three facing sets of the six-sided tube 21. A pair of rod-receiving holes 26 can be situated near the top edge 22 on the same facing sides as the middle pairs of holes 24-25.

The perch-receiving holes 25 are each positioned a certain distance downward from a corresponding port-insert-receiving hole 24. The port-insert-receiving holes 24 and/or the perch-receiving holes 25 can have keyed contours. The rod-receiving holes 26 can have a non-keyed circular shape.

In the illustrated embodiment, the keyed contour of the port-insert-receiving holes 24 comprises a central circular shape and narrow upper and lower rectangular notches 27. The keyed contour of the perch-receiving holes 25 comprises a circular central shape, wide upper and lower oval notches 28, and narrow left and right oval notches 29.

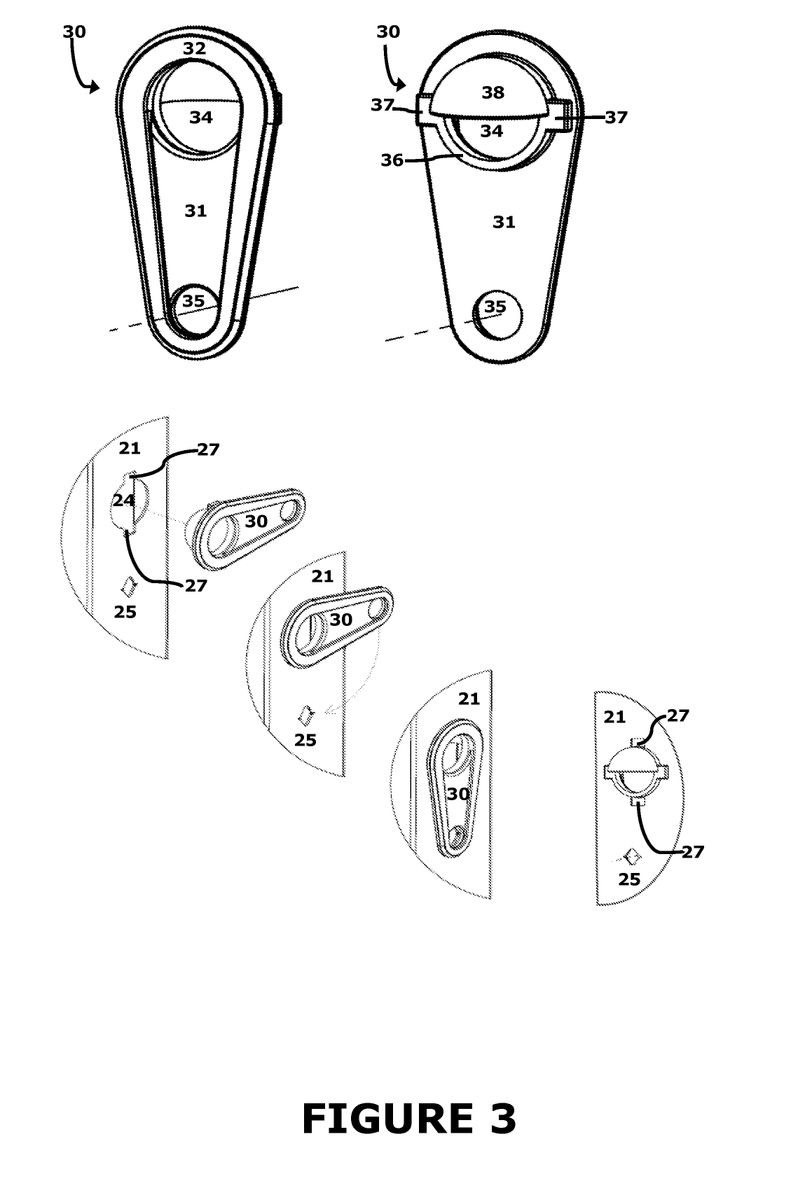

Referring to FIG. 3, the port inserts 30 each comprise an ovate-shaped stage 31 with a raised outer perimeter 32. An upper opening 34 and a lower opening 35 on the stage 31 are situated to align with holes 24 and 25 on housing tube 21. A sleeve 36 extends inward from the upper opening 34, this sleeve 36 having a central circular shape and narrow left and right rectangular notches 37. An upper rim of the sleeve 36 can be provided with brim 38.

To assemble a port insert 30 to the housing 20, the stage 31 is turned sideways so that the notches 37 in its upper opening 34 are aligned with the notches 27 in a port-receiving opening 24. The sleeve 36, the notches 37, and the brim 38 and then inserted through the tube opening 24. The stage 31 is then twisted downward to lock the port 30 in a position whereat its lower opening 35 is aligned with the corresponding perch-receiving hole 25. The port inserts 30 can be removed in a reverse manner from the housing tube 21.

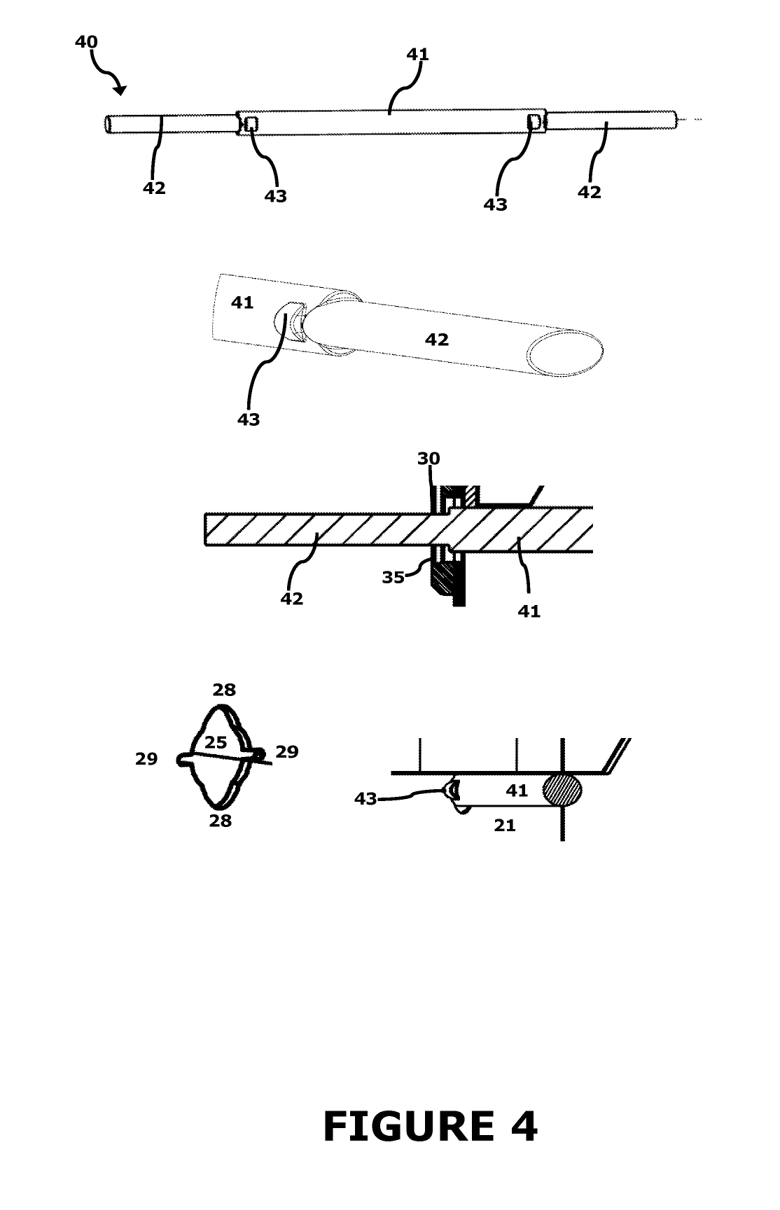

Referring to FIG. 4, each perch 40 includes a central portion 41, end portions 42, and locking nubs 43. The central portion 41 has a circular cross-sectional shape and spans the diameter of the housing tube 21. The end portions 42 each have oval cross-sectionals shape which elongate in the horizontal dimension. A pair of locking nubs 43 is positioned on each end of the central portion 41 and they each extend laterally outward therefrom.

To assembly a perch 40 to the housing 20, it is turned sideways to align its oval end portions 42 with the wide oval notches 28 of a perch-receiving hole 25 in the tube 21. The perch 40 is then inserted through this hole 25 and through the hole 25 on the opposite side of the tube 21. The perch 40 is then twisted sideways so that the locking nubs 43 are seated in the narrow oval notches 29. The perch 40 can be removed in a reverse manner. If it is used in conjunction with a port insert 30, the same steps are followed, with the perch 40 also be inserted through the insert's lower opening 35.

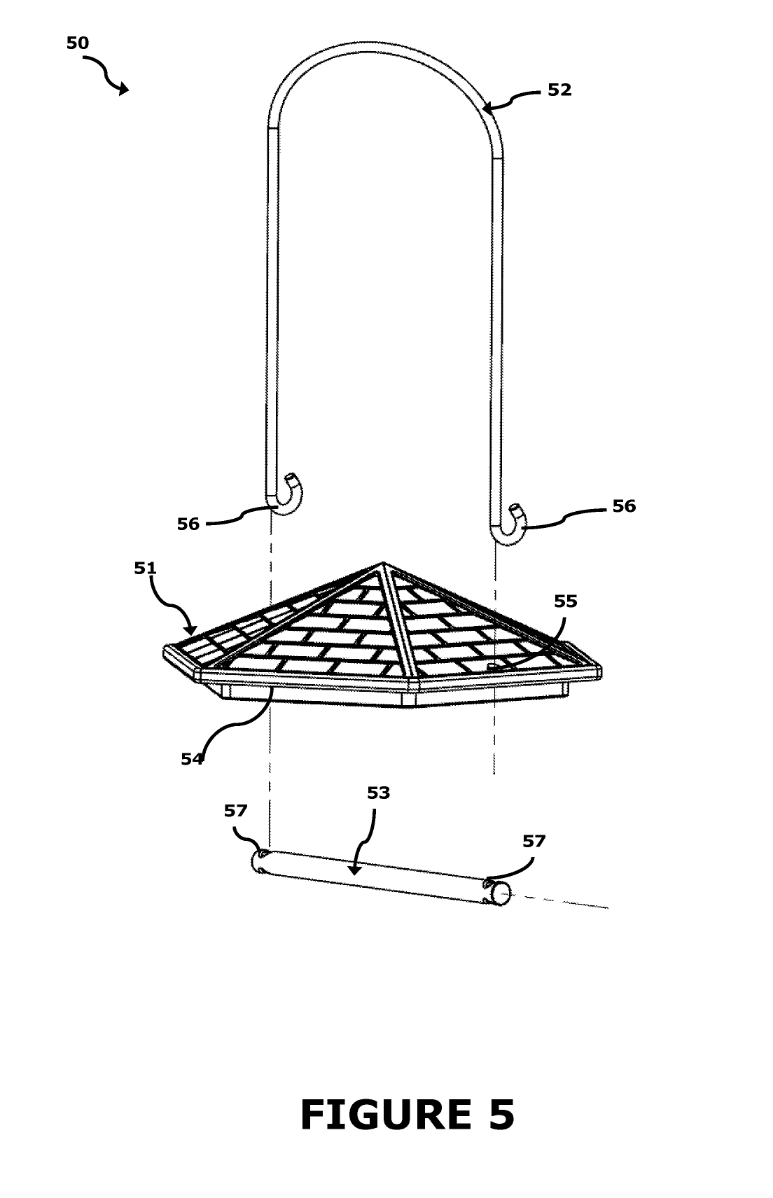

Referring to FIG. 5, the roof 50 comprises an awning 51, a hanger 52, and a rod 53. The awning 51 can comprise a plastic molded body with a hexagonal rim 54 and hanger-accommodating apertures 55. The hanger 52 can comprise a curved metal wire having J-shaped ends 55. The rod 53 can comprise a cylindrical member with apertures 56 through its ends for insertion of the hanger's J-shaped ends 55.

To assembly the roof 50 to the housing 20, the hanger ends 55 are inserted through the awning apertures 55. The rod 53 is inserted through the rod-receiving holes 26 in the housing tube 21. The awning 51 is then lowered downward so that its hexagonal rim 54 is inserted into the upper edge 22 of the housing tube 21. The roof 50 can be removed from the housing 20 in a similar, reverse, fashion. And the awning 51 can be lifted from the housing 20 by simply sliding it upward on the hanger 20, to gain access to the inside of the housing 20.

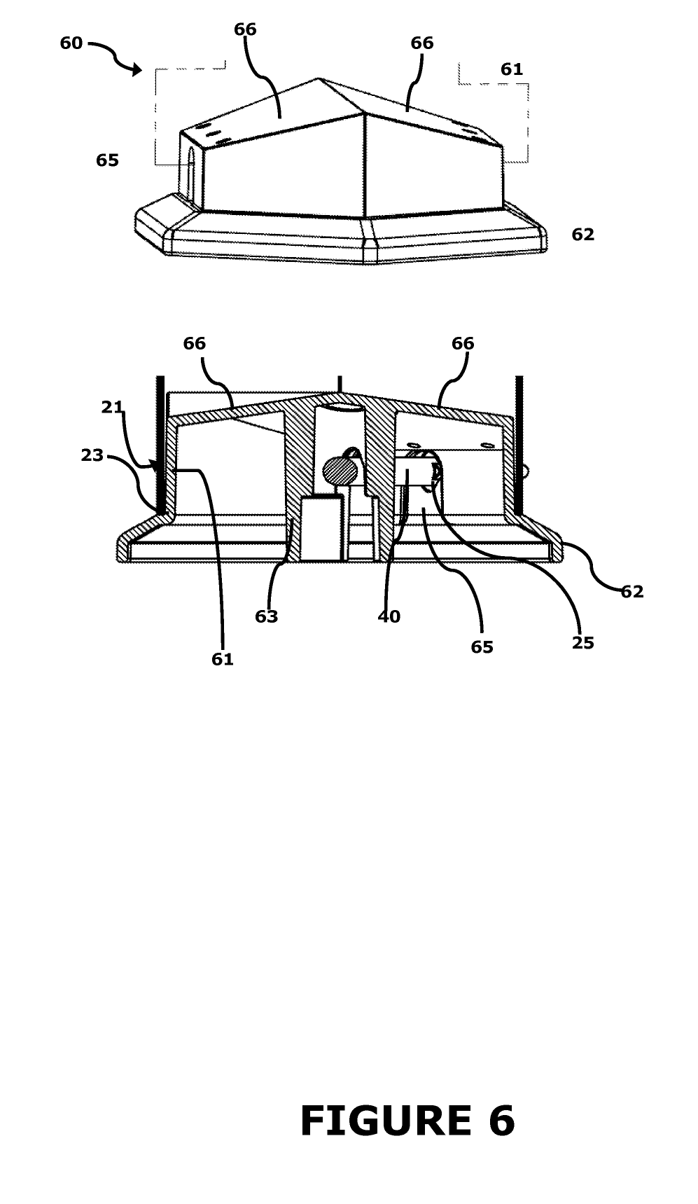

Referring to FIG. 6, the base 60 comprises an upper pedestal 61, a lower skirt 52, and an interior podium 63. The pedestal 61 is shaped and sized for insertion into the lower edge 23 of the housing tube 21. The skirt 63 flares outward from the pedestal 61 and extends below the housing 20. The interior podium 53 has a hollow interior shape that extends downward from the top of the pedestal 61 and has a hollow interior.

With the illustrated hexagonal housing, for example, the pedestal 61 has three pairs of facing sides. One pair of these sides includes perch-receiving slots 65. And the top of the pedestal 61 can comprise a pair of ramps 66 which slope downwards towards this pair of facing sides.

To assembly the base 60 to the housing 20, the pedestal 61 is inserted into the bottom of the tube 21 and the perch-receiving slots 65 are aligned with lowermost perch-receiving holes 25. The perch 40 is then assembled in the same manner as described above. The base 60 can be removed from the housing 20 in a similar manner starting with removal of the perch 40.

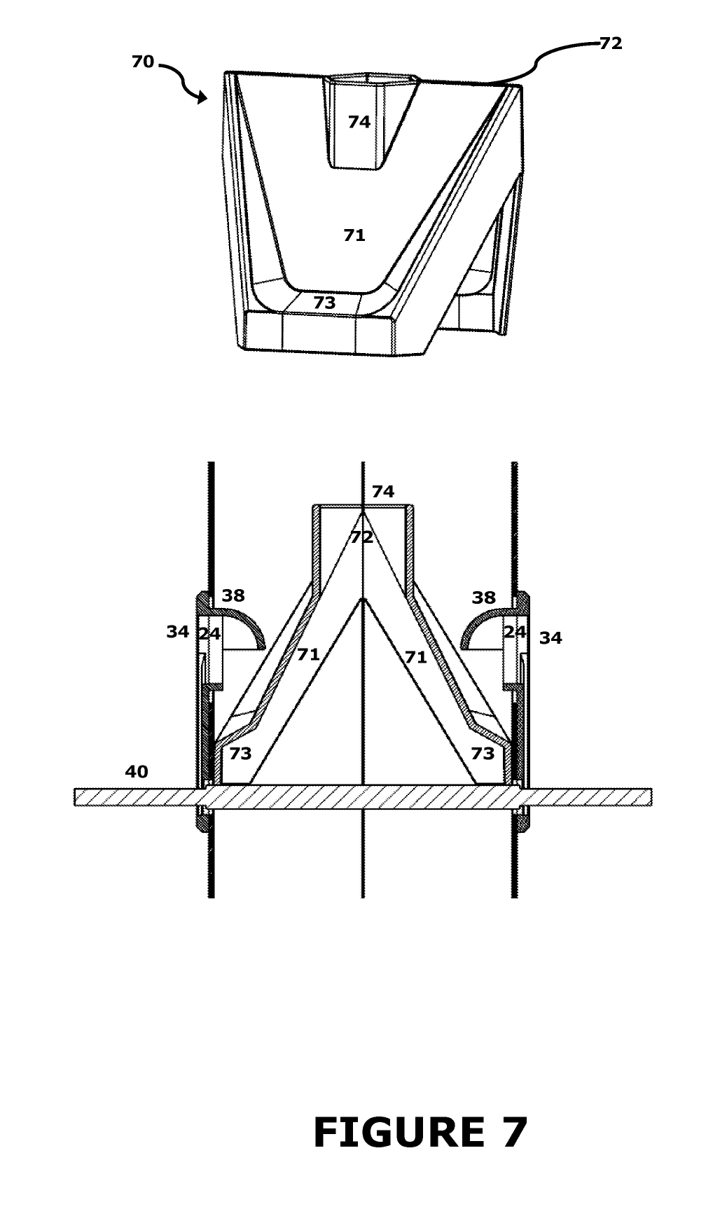

Referring to FIG. 7, the birdfeeder 10 can additionally comprise a baffle 70 associated with a pair of feed ports 30 and/or with a perch 40. The baffle 70 serves to funnel birdfeed towards the feed port openings 24 so that it can be eaten by birds sitting on the perches 40. In the birdfeeder 10, the upper and middle feed-port pairs and/or perches 40 would be provided with a baffle 70. With the lowermost feed-port pair and/or perch 40, the pedestal ramps 66 perform this funneling function.

The baffle 70 comprises a pair of ramps 71 which slope downward from a top crest 72 to lower slides 73 aligned with feed-port receiving holes 24 in the housing tube 21. The top crest 72 is sized to extend diametrically across the hexagonal tube 21 (i.e., from corner to corner), while each slide 73 is sized to fit snuggly across one of the six sides. A chimney 74 extends downward through the crest 72 and adjacent ramp regions, to provide a birdfeed passageway to a lower baffle or the base 60 (e.g., when the roof awning 51 is lifted and birdfeed is poured into the housing tube 21 through its top edge 22).

To assemble the baffles 70, they are inserted into the housing tube 21 in an orientation aligning their slides 73 with corresponding feed-port pairs 30 and perch 40. When in position, the ramps' bottom edges will rest upon the associated perch 40. With more than one baffle 70 and/or perch 40, baffle insertion must be coordinated with the perch assembly.

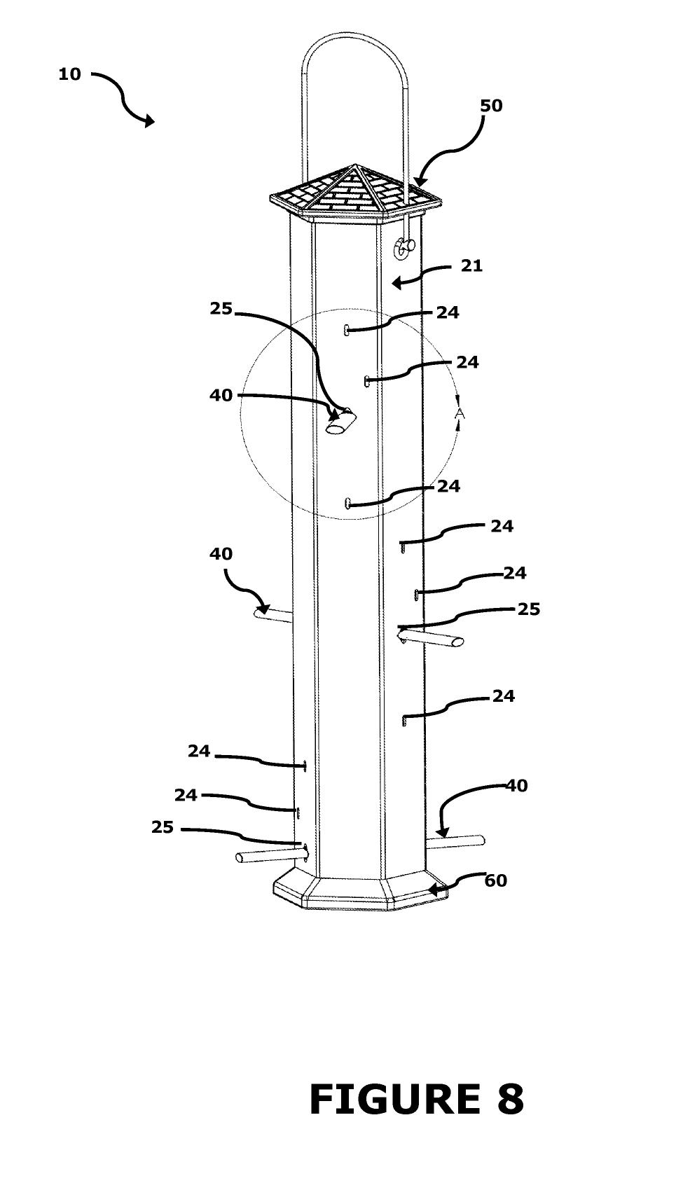

Referring to FIG. 8, a birdfeeder 10 is shown without feed-port inserts 30, whereby the housing holes 24 alone serve as feed ports. This design may be preferable, for example, when very small birdfeed (e.g., thistle) is used. The holes 24 can be arranged in the housing tube 21 near the perch holes 25 whereby they will be near the perches 40 in the birdfeeder 10. The feed-port holes 24 can be situated above and/or below the closest perch hole 25, they can be vertically aligned with the perch hole 25 or with each other, and/or they can be vertically offset with the perch hole 25 and/or each other.

One now may appreciate a birdfeeder 10 is provided wherein components can be securely attached, but still easily removed, from the housing 20. Although the birdfeeder 10, the housing 20, the feed ports 30, the perches 40, the roof 50, the base 60, and/or the baffles 70 are shown and described as having certain forms and fabrications, such portrayals are not quintessential and represent only some of the possible of adaptations of the claimed characteristics. Other obvious, equivalent, and/or otherwise akin embodiments could instead be created using the same or analogous attributes.

1. A birdfeeder comprising a housing and one or more feed port inserts removably attached to the housing; wherein:
the housing comprises a tube having a hole for each feed-port insert, the hole having a keyed contour;
each feed-port insert comprises a stage, an opening in the stage, and a sleeve extending inward from the opening, the sleeve having a keyed contour complimentary to that of the hole; and
when the stage is turned, the sleeve can be inserted into the hole and when the stage is turned back after insertion of the sleeve, the feed-port insert is securely attached to the housing tube.

2. A birdfeeder as set forth in claim 1, wherein the hole has a central circular shape with notches extending in opposite directions therefrom, and wherein the sleeve has a circular shape with notches extending therefrom in opposite directions different from those of the hole.

3. A birdfeeder as set forth in claim 2, wherein the notches of the hole extend upward and downward and wherein the notches of the sleeve extend leftward and rightward.

4. A birdfeeder as set forth in claim 1, further comprising at least one perch removably attached to the housing.

5. A birdfeeder as set forth in claim 4, wherein the housing includes a pair of holes for each perch and the perch is adapted for insertion through a pair of holes in the housing tube and through openings in an aligned pair of the feed-port inserts.

6. A birdfeeder as set forth in claim 1, further comprising a housing and a roof removably attached to the housing; wherein:
the housing comprising a housing tube having an upper edge and a pair of rod-receiving openings;
the roof comprising an awning covering the top of the housing tube, a hanger slidably supporting the awning, a rod removably secured to the lower ends of the hanger; and
the rod extends through the pair of rod-receiving openings in the housing tube and is removable therefrom after removal of the hanger.

7. A birdfeeder as set forth in claim 1, further comprising a base removably attached to the housing; wherein the housing comprises a housing tube having a lower edge, and wherein the base comprises a pedestal shaped and sized for insertion into the lower edge of the housing.

8. A birdfeeder as set forth in claim 7, comprising a perch and wherein:
the housing tube includes perch-receiving slots;
the base pedestal includes perch-receiving slots; and
the perch is shaped and sized for insertion through the perch-receiving openings in the housing tube and for insertion through the perch-receiving slots in the base pedestal.

9. A birdfeeder as set forth in claim 1, comprising a baffle removably attached to the housing; wherein the housing comprises a housing tube having feeding holes and the baffle comprises a pair of ramps which slope downward from a top crest to lower slides aligned with the holes.

10. A birdfeeder as set forth in claim 9, comprising one or more perches removably attached to the housing, a roof removably attached to the housing, and a base removably attached to the housing;
wherein the housing comprises a housing tube having a pair of horizontally aligned holes for each perch and wherein the base has a pair of perch-receiving slots aligned with the lowermost pair of housing holes.

11. A birdfeeder as set forth in claim 1, comprising one or more perches removably attached to the housing; wherein:
the housing comprises a housing tube having a pair of horizontally aligned holes for each perch;
the housing tube includes at least two holes situated near the perch to serve as a feed port, these two holes being vertically offset from each other.

12. A birdfeeder as set forth in claim 1, comprising one or more perches removably attached to the housing; wherein:
the housing comprises a housing tube having a pair of horizontally aligned holes for each perch,
the housing tube includes at least two holes situated near the perch to serve as a feed port, one of these holes being located above the perch and the other hole being located below the perch.

13. A birdfeeder as set forth in claim 1, comprising at least one perch removably attached to the housing and a roof removably attached to the housing; wherein:
the housing includes a housing tube having an upper edge and a lower edge;
the housing tube includes a pair of perch-receiving holes for each perch;
each perch is adapted for insertion through the perch-receiving holes in the housing tube and through perch-receiving openings in an aligned pair of the feed-port inserts;
the housing tube has a pair of rod-receiving openings;
the roof comprises an awning covering the top of the housing tube, a hanger slidably supporting the awning, a rod removably secured to the lower ends of the hanger; and
the rod extends through the pair of rod-receiving openings in the housing tube and is removable therefrom after removal of the hanger.

14. A birdfeeder as set forth in claim 13, further comprising a base removably attached to the housing; and wherein the base comprises a pedestal which is shaped and sized for insertion into the lower edge of the housing.

15. A birdfeeder as set forth in claim 14, comprising a bottom perch which is shaped and sized for insertion through the perch-receiving openings in the housing tube and for insertion through the perch-receiving slots in the base pedestal.

16. A birdfeeder as set forth in claim 15, comprising a baffle removably attached to the housing; wherein the housing tube has feeding holes and the baffle comprises a pair of ramps which slope downward from a top crest to lower slides aligned with the feeding holes.

17. A birdfeeder as set forth in claim 14, comprising a baffle removably attached to the housing; wherein the housing tube has feeding holes and the baffle comprises a pair of ramps which slope downward from a top crest to lower slides aligned with the feeding holes.

18. A birdfeeder as set forth in claim 13, comprising a baffle removably attached to the housing; wherein the housing tube has feeding holes and the baffle comprises a pair of ramps which slope downward from a top crest to lower slides aligned with the feeding holes.

19. A birdfeeder comprising a housing, and a roof removably attached to the housing; wherein:
the housing comprising a housing tube having an upper edge and a pair of rod-receiving openings;
the roof comprising an awning covering the top of the housing tube, a hanger slidably supporting the awning, a rod removably secured to the lower ends of the hanger; and
the rod extends through the pair of rod-receiving openings in the housing tube and is removable therefrom after removal of the hanger.

20. A birdfeeder comprising a housing, a perch removably attached to the housing, and a base removably attached to the housing; wherein:
the housing comprises a housing tube having a lower edge and a pair of perch-receiving openings adjacent the lower edge;
the base comprises pedestal shaped and sized for insertion into the lower edge of the housing tube, the pedestal including perch-receiving slots; and
the perch is shaped and sized for insertion through the perch-receiving opening in the housing tube and for insertion through the perch-receiving slots in the base pedestal.
